(19) United States
(12) Patent Application Publication
(10) Pub. No.: US 2012/0280525 A1
(43) Pub. Date: Nov. 8, 2012

(54) SCOOP SET

(76) Inventor: Jannie Lou Tharp, Willamina, OR (US)

(21) Appl. No.: 13/068,185

(22) Filed: May 5, 2011

(51) Int. Cl. A47J 43/28; A47F 13/08

(52) U.S. Cl. 294/176

(57) ABSTRACT

A scoop set with a plurality of scoop members and a plurality of extension rod members that attach to a receiving member found on each scoop. Each scoop member has a specific material collecting geometry designed to accommodate a specific jar or bottle construction. Each scoop member is designed to help remove the last remains of food items or cosmetic material or other liquids, oils, creams or solids found at the bottom of a jar or bottle. Each extension rod receiving member has a magnet embedded in its distal end. The extension rods each have a hollow end capable of slidably receiving the extension rod receiving member. The hollow portion of the extension rod terminates in a ferrous metal plate that can removably engage the extension rod receiving magnet.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of specialty scoops and more specifically to scoop set for removing the contents from the bottom of variously shaped jars or bottles.

Jars and bottles have been used for hundreds of years to store many types of materials including food items, cosmetic items and other items that include liquids, oils, powders, creams and solid pellet type items.

Many of these items, especially cream type items are hard to remove completely when the items are residing at the bottom of a jar or bottle. Standard spoons, knives or other utensils are not specifically designed to match the lowest portion of the side walls, where the walls meet the bottom inside surface of the jar or bottle. This can be frustrating to a person who wishes to use the total contents of the jar or bottle.

Some people have proposed solutions to this problem for removing the last remains of specific contents of a jar or bottle. For example L. F. Johnstone et al, in his U.S. Pat. No. 2,727,777 discloses a utensil for removing food from containers. It is specifically designed for removing items such as olives from the bottom of a jar. The scoop portion is curved, and includes two pointed tips to help scoop or spear olives even if they are at the very bottom of the jar or bottle. In another patent, Joel Delman et al in his U.S. Pat. No. 6,578,725 discloses a container that has a lid that includes a built in scoop portion to help remove the contents from the bottom of the jar or bottle.

However, there is a deficiency in the prior technology in that none of the previous designs provides an entire scoop set and a plurality of interchangeable rod or handle members that can allow a person to remove the bottom most contents of a jar or bottle regardless of bottle or jar shape, height, mouth size or offset between the mouth and the inside wall of the jar or bottle.

### BRIEF SUMMARY OF THE INVENTION

The primary object of the invention is to provide an assortment of small scoops that help a person extract the last remains of a liquid, cream or solid material that is found at the bottom of any standard jar or bottle.

Another object of the invention is to provide a scoop handle that can be adjusted in length and angle to reach the bottom of a specific jar or bottle.

Another object of the invention is to provide an assortment of scoops that are each designed to interact with a specific jar or bottle shape.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a scoop set comprising: a plurality of scoop members, each scoop member having a material collecting geometry, each said scoop member designed to help remove the last remains of food items or cosmetic material or other liquids, oils, creams or solids found at the bottom of a jar or bottle, each said scoop member terminating in an elongate extension rod receiving member, said elongate extension rod receiving member having a cross section other than round, said elongate extension rod receiving member having a magnet embedded in its distal end, a plurality of extension rods, said extension rods each having a hollow end capable of slidably receiving said extension rod receiving member, and said hollow portion of said extension rod terminating in a ferrous metal plate that can removably engage said extension rod receiving magnet.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of one of the scoops of the invention in use in a jar with rounded sides.

FIG. 2 is a perspective view showing a group of scoop members, one of which can be selected for a specific jar or bottle geometry.

FIG. 3 is a side exploded view of a scoop and extension rod combination.

FIG. 4 is a side section view of a jar with a side view of a scoop and extension member in the use position.

FIG. 5 is a partial perspective view of a jar with a scoop member and extension rod inserted in the use position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

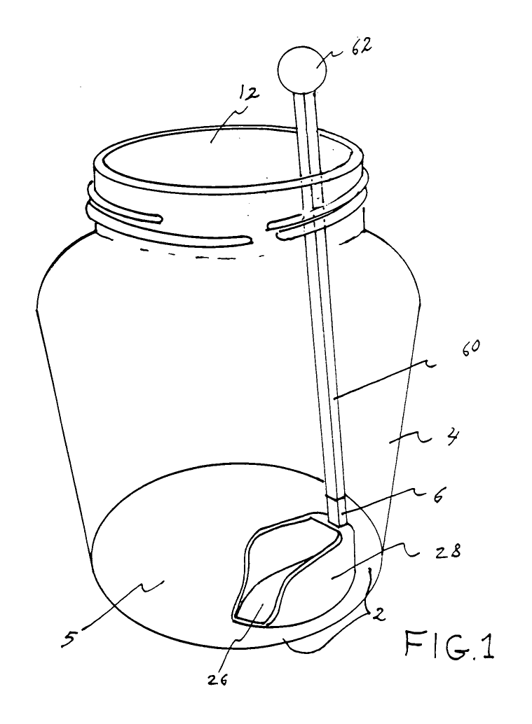

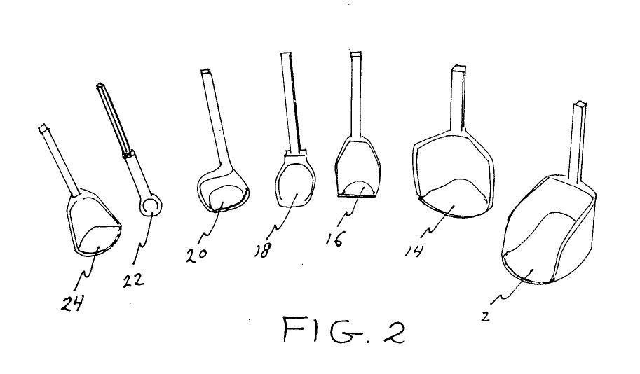

Referring to FIG. 1 we see a perspective view of a scoop member 2 located at the bottom of a transparent jar 4. The scoop member 2 has an elongate receiving member 6 that is connected to a straight extension rod 60 which terminates in ball shape 62. The side surface 28 of the scoop 2 is curved to approximately match the inside wall of the jar 4. the bottom 26 of the scoop 2 is flat so that as the user slides the bottom 26 of the scoop 2 against the flat bottom 5 of the jar 4, the contents located at the bottom of the jar 4 would be scooped up for removal. If a person tried this same operation with a standard table spoon or knife, the person would have a less likely chance of scooping the last remains of items sitting at the bottom of the jar 4 because the geometry of the shape of standard spoons and knives does not conform exactly to shape of the bottom and side walls of the jar 4. FIG. 7 shows a top section view of the jar 4 bisected for the sake of clarity showing scoop 2 placed along the inside wall of the jar 4. This view clearly shows that the outside curve of the scoop wall 28 matches the inside wall of the jar 4. The floor 26 of the scoop member 2 is flat against the floor 5 of the jar 4.

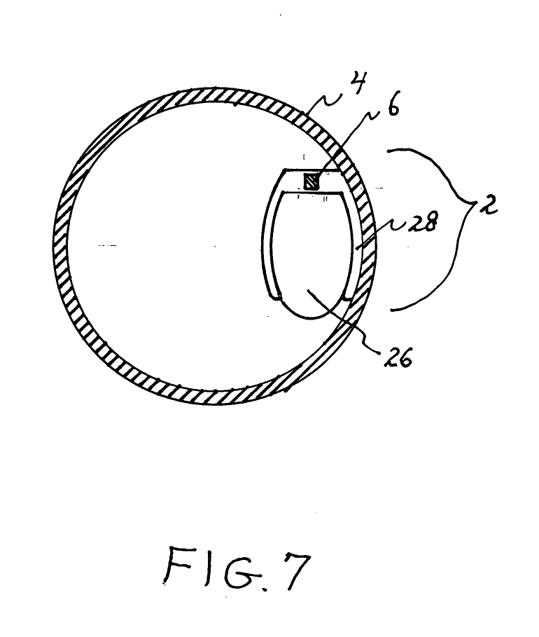

Although the scoop member 2 shown in FIGS. 1 and 2 works well for jars with curved side walls, it is not ideal for jars with flat side walls. Additionally, the mouths of bottles and jars are different sizes an the overall height of bottles and jars are also different sizes which would require different shaped scoops and extension rods. The group of scoops 2, 14, 16, 18, 20, 22, 24 shown in the perspective view in FIG. 2 are designed to accommodate a wide variety of sizes of jars and bottles. Scoops 14 and 24 are designed for jars of bottles with flat sides. Scoop member 14 is for larger jars such as the one shown in the partial perspective view in FIG. 5. In this case the flat wall of the scoop 14 is able to slide in close proximity to the inside flat wall of transparent jar 90 and the flat bottom 7 of the scoop member 14 is able to slide along the flat bottom surface 91 of jar 90.

Referring back to FIG. 2 we see other scoop members 22, 20, 18, 16, as well as already described scoops 24, 14 and 2. Scoop member 22 can be inserted into very small bottles that may contain expensive lotions such as high priced skin cream, where retrieving even a small amount of product from the bottom of the bottle can mean dollars worth of savings. Scoop member 20 has a side wall attached half of the bottom plate which can make it easier, in some bottle geometries to slide, swivel and lift the contents out from the floor of the bottle. Scoop member 18 is more spade shaped and can be used to push contents along the floor of a bottle or jar and then, while the contents are clinging to the spade shape, be lifted out of the mouth of the bottle. Scoop member 16 is a smaller version of scoop member 2 and can be used for bottles and jars that have smaller diameters.

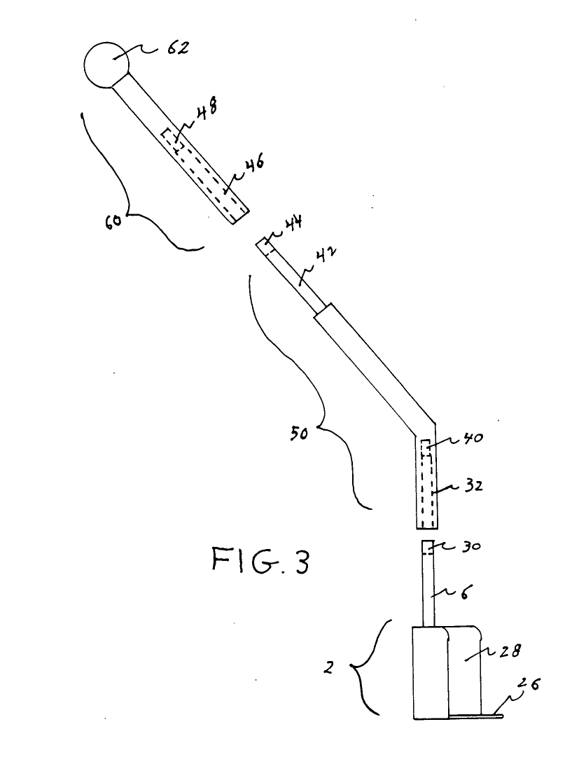

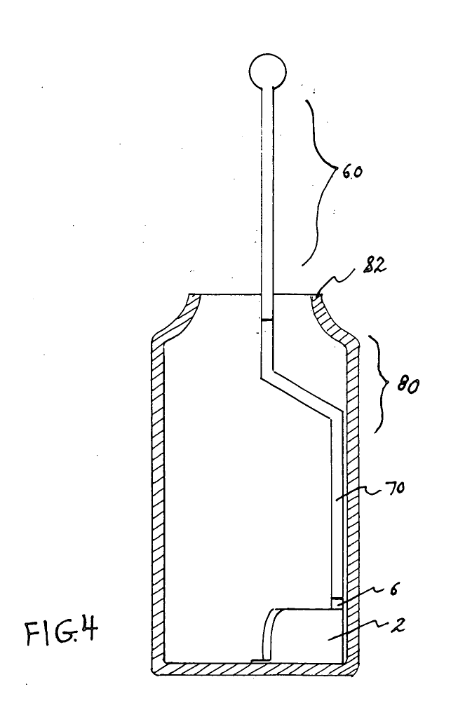

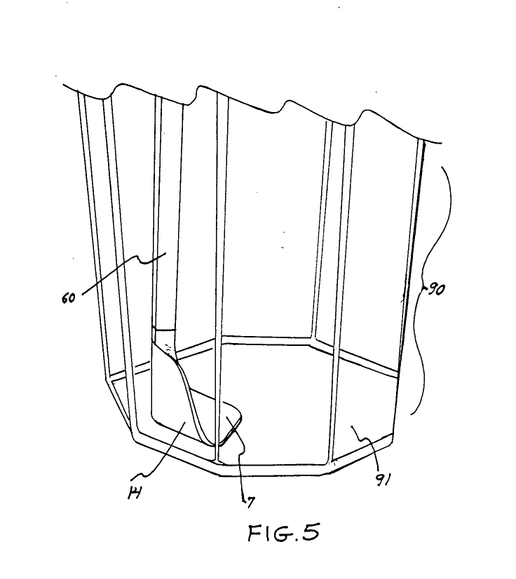

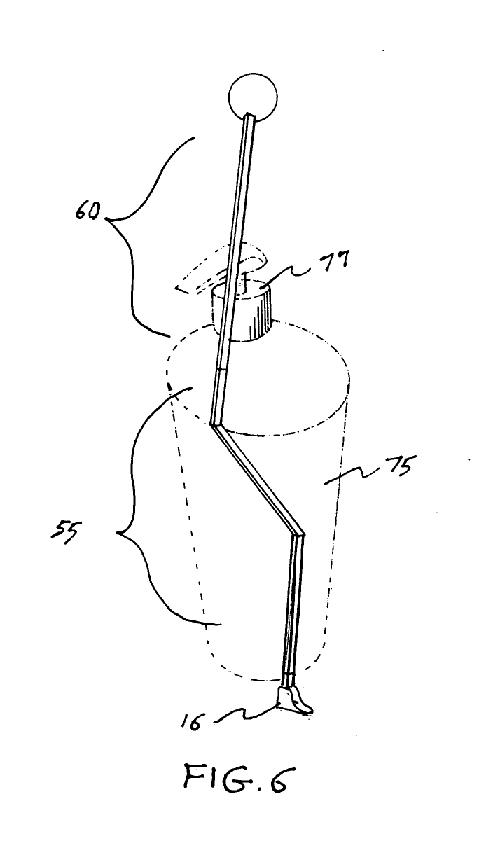

FIG. 3 shows a side exploded view of a scoop member 2 and extension rods 50 and 60. Scoop member 2 is made up of flat base plate 26 and attached side walls 28. Elongate extension rod receiving member 6 is fixedly attached to the top of scoop member 2. The top portion of the receiving member 6 terminates in a magnet 30. The receiving member 6 has a square cross section in this embodiment, however, the cross section may be any shape other than a perfect circle which prevents the scoop 2 from unintensionally swiveling on the extension rod when slid into a mating female socket of an extension rod member as shown by dotted line 32 in the bottom portion of extension rod 50. A ferrous metal plate 40 is fixedly attached at the far end of hollow receptacle 32. Hollow receptacle 32 matches the shape the cross sectional shape of receiving member 6 so that when receiving member 6 is slid into receptacle 32, the magnet 30 contacts the ferrous metal plate 40 and holds the scoop member 2 in place during use, but can be easily removed after use. Extension member 50 is angled and extension member 60 is straight. Straight extension member 60 terminates in ball shape 62 which helps the user twist and maneuver the entire scoop assembly when trying to get the last remains out of a jar or bottle. Straight member 60 attaches to angled member 50 in the same way as angled member 50 attaches to receiving member 6. Magnet 44 can engage metal plate 48 as shaft 42 slides into hollow receptacle 46. The angled extension rods 50, and 70, shown in FIG. 4, help let the user design the correct geometry of extension rod to accommodate any bottle or jar. For example, angled extension rod 70 is joined to straight rod 60 in the side view shown in FIG. 4. The section view of jar 80 shows that the diameter of mouth 82 of the jar 80 is smaller than the main portion of the jar. In this offset extension rod design is desirable in order for the side wall of scoop 2 to be in close contact with the inside of wall of jar 80 thereby insuring that the user can scrap all of the contents of the jar away from the walls and floor of the jar 80 and out of jar mouth 82.

FIG. 5 is a partial perspective view of a jar 91 having a plurality of flat walls 91. The flat side walls of scoop member 14 and flat base plate 7 allow the scoop member 14 to remove the maximum amount of contents from the bottom of jar 90. Extension rod 60 is attached to scoop 14 in the same way as described above. All the scoop members have identical receiving members 6. And all extension rod members have identical hollow portions 32, 46 that allow the ends 6 of any scoop member to slide and magnetically lock as described above.

FIG. 6 shows a phantom view of a lotion bottle 75 that is quite tall and has an offset cap 77 and corresponding bottle mouth. The ideal scoop and extension rod assembly is shown just in front of the bottle 75. In this case, scoop member 16 has been attached to double angled extension rod 55. Straight extension rod 60 has then been attached to double angled rod 55 to create a custom extension rod and scoop that is ideal for removing the contents from the bottom of bottle 75.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. scoop set comprising:
a plurality of scoop members;
each scoop member having a material collecting geometry;
each said scoop member designed to help remove the last remains of food items or cosmetic material or other liquids, oils, creams or solids found at the bottom of a jar or bottle;
each said scoop member terminating in an elongate extension rod receiving member;
said elongate extension rod receiving member having a cross section other than round;
said elongate extension rod receiving member having a magnet embedded in its distal end;
a plurality of extension rods;
said extension rods each having a hollow end capable of slidably receiving said extension rod receiving member; and
said hollow portion of said extension rod terminating in a ferrous metal plate that can removably engage said extension rod receiving magnet.

2. A scoop set as claimed in claim 1 wherein a first said scoop member includes at least two flat side wall panels and an attached flat bottom panel designed to remove the remains of items found at the bottom of flat walled jars or bottles.

3. scoop set as claimed in claim 1 wherein a second said scoop member includes at least one curved wall panel attached to a flat bottom panel designed to remove the remains of items found at the bottom of round walled jars or bottles.

4. scoop set as claimed in claim 1 wherein a third said scoop member includes a spade like design designed to scrape the remains of items found at the bottom of jars or bottles.

5. scoop set as claimed in claim 1 wherein a first said extension rod includes a straight rod member.

6. scoop set as claimed in claim 1 wherein a second said extension rod includes an offset angled rod member.

7. scoop set as claimed in claim 1 wherein said straight extension rod members and said offset angled rod members can be removable attached to each other by said receiving magnets and said ferrous metal plates to create a custom extension rod that can be designed for a jar or bottle with a specific length, mouth opening size and mouth to side wall offset.
